(19) United States
(12) Patent Application Publication
(10) Pub. No.: US 2013/0116075 A1
(43) Pub. Date: May 9, 2013

(54) METHOD AND APPARATUS FOR MANIPULATING CHAIN SEGMENTS

(71) Applicants: Thomas Miller, Goleta, CA (US); James Gilpin, Goleta, CA (US)

(72) Inventors: Thomas Miller, Goleta, CA (US); James Gilpin, Goleta, CA (US)

(21) Appl. No.: 13/669,310

(22) Filed: Nov. 5, 2012

Related U.S. Application Data
(60) Provisional application No. 61/555,350, filed on Nov. 3, 2011.

(51) Int. Cl. F16H 55/30

(52) U.S. Cl. CPC F16H 55/30
USPC 474/155

(57) ABSTRACT

A chain wheel designed to haul in, pay out and/or guide a mooring chain that includes multiple chain sizes. In one configuration, the chain wheel is a dual chain wheel that includes pockets sized to support a larger chain size and pockets sized to support a smaller chain size. The pockets include flat surfaces that support links of the chain as it passes over the chain wheel. The chain wheel also includes whelps designed to support and guide chain segments into proper alignment with the chain wheel.

### BACKGROUND OF THE INVENTION

Offshore structures, such as floating production, drilling or construction platforms or spar buoys generally are moored in a desired location through the use of chains or cables secured between the platform and anchors on the ocean floor. Typically, the practice for mooring floating platforms includes extending a chain from the ocean anchor, through a fairlead device secured to the bottom of a platform column, to chain hauling equipment and chain stopper on the deck of the platform.

Mooring platforms in place over a drilling location often require the implementation of many chains, fairlead devices, anchors and chain equipment because of the massive size of the platforms. For example, the deck area of a platform is typically large enough to hold one or more buildings for housing workers and machinery, a number of cranes, and a drilling tower or limited production facilities.

Also, floatation of platforms is typically provided by a pair of large submerged pontoons. In such structures, columns are utilized, some as large as 32 feet in diameter, to support the deck on the pontoons. As a consequence of the platform's massive structure, several fairlead devices are often secured to each column of the platform and mooring chains are run through each of the fairlead devices from the anchors to chain hauling equipment on the deck.

Installation of floating production vessels offshore requires a method to haul in and guide pre-laid mooring chains into the chain fairlead and stopper mounted on the production vessel. The current practice is to feed (pay out) either a messenger chain or messenger wire rope from the production vessel through the on-vessel mooring equipment, and out to an anchor handling boat to connect the messenger line to the pre-laid permanent platform chain. The messenger line and associated mooring chain are then drawn into the production vessel.

The present invention relates generally to a method and/or apparatus for hauling in, paying out, guiding, storing, transferring, stabilizing and/or manipulating chains, cables, or ropes. In particular, the present invention relates to a method and apparatus for hauling in or paying out mooring chains of different sizes. In one application, the method and apparatus are used to apply rotational power or braking and/or to guide chain lines made out of different chain sizes.

### BRIEF DESCRIPTION OF THE DRAWINGS

FIG. 1 is a front view of a dual pocket chain wheel according to the invention;

FIG. 2 is a side view of the dual pocket chain wheel in FIG. 1;

FIG. 3 is a side partial sectional view of an alternative embodiment of a dual pocket chain wheel according to the invention with a groove designed to carry the smaller chain in a “+” (plus) orientation;

FIG. 4 is a front sectional view of a dual pocket chain wheel in FIG. 3 with a groove designed to carry a smaller chain in a “+” orientation;

FIG. 5 is a side partial sectional view of another alternative embodiment of a dual pocket chain wheel according to the invention with a groove designed to carry the smaller chain in an “x” orientation; and

FIG. 6 is a front sectional view of a dual pocket chain wheel with a groove designed to carry the smaller chain in an “x” orientation.

FIG. 7 is a side partial sectional view of another alternative embodiment of a dual pocket chain wheel according to the invention with a groove designed to carry the larger chain and flats to carry the smaller chain.

### DETAILED DESCRIPTION OF THE INVENTION

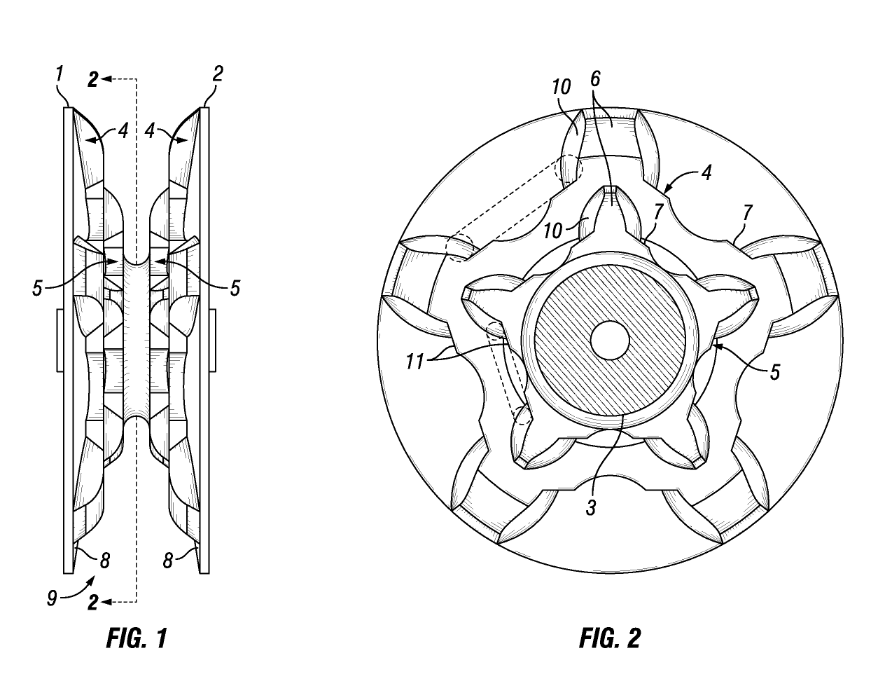

FIGS. 1-7 are provided as illustrations of a method and apparatus for hauling in, paying out and/or guiding chain during mooring operations. Multiple aspects of the invention are embodied in the method and apparatus illustrated therein. However, it should be noted that the detailed description of this preferred system and method which follows is provided to facilitate description of the inventive method and apparatus. It will be apparent to one skilled in the art, upon reading the detailed description provided and viewing the accompanying drawings, that the invention or certain aspects of the invention is also adapted for use in or with other environments, with respect to various other chain, cable, or rope uses, and by various uses other than mooring operations. Accordingly, the present invention is not intended to be limited to the methods, processes, and structures specifically described and illustrated herein. The method and apparatus can be used with any number of operations where guiding and controlling chain and cable of varying lengths and sizes are required. For purposes of description only, chains will be referred to as mooring chains. As noted, however, this is not intended to limit the disclosed invention to such uses.

Referring to the FIGS. 1 and 2, there is shown a dual chain wheel capable of guiding, applying rotational power, or braking to two different chain sizes. The dual pocket chain wheel shown in FIGS. 1 and 2 comprises two drums (1) and (2) attached about a drum hub (3) in spaced parallel relation. Aligned along the inside face of both drums are large wildcat profiles (4). Wildcat profiles are defined by the shaped portion of the dual chain wheel that is designed to orient and seat the mooring chains. The dual pocket chain wheel shown in FIGS. 1 and 2 has two wildcat profiles for the two sizes of chain. A small wildcat profile (5) is used to guide, haul in, and/or pay out the smaller chain size. The large wildcat profile (4) is used to guide, haul in, and/or pay out the larger chain size. The large and small wildcat profiles are in shown aligned with each other but they may be in any alignment or in an adjustable relationship with each other. In addition, the wildcats may be adapted to be removable from the chain wheel drum such that different size wildcats may be used depending on the chain size.

The large and small wildcat profiles (4) and (5) include whelps (6) and pockets (7). The Whelps (6), shown in front view in FIG. 1, extend from the interior drum face (8) to an interior position (9). The whelps (6) are spaced evenly around the circumference of the drums (1) and (2). The number of whelps (6) can vary depending on the desired use and chain size.

Between each whelp (6) are chain pockets (7). The chain pockets (7) are shaped and spaced to seat alternating chain sections as the mooring chains are drawn in or payed out. A section of large chain and small chain are shown in FIG. 2 seated in chain pockets (7). Alternating chain sections (not shown) would be standing on edge and would not be seated in the chain pockets.

The chain pockets (7) are shaped and sized such that when the chain sections are seated in the pockets they are in contact with whelp flats (10) and pocket flats (11). The pocket flats (11) help distribute the load from the chain across seated chain links. In this manner, the pocket flats (11) prevent the chain load from being concentrated at the center of each chain link as it passes over the chain wheel. The pocket flats (11) in conjunction with the whelp flats (10) may also be used to transmit rotational power and braking to chain sections.

FIGS. 1 and 2 depict a dual pocket chain wheel configuration capable of guiding, transmitting rotational power, and braking to two different chain sizes. Opposing whelps are shaped and spaced to guide alternating sections of the larger sized mooring chain vertically into the interior channel of the chain wheel. For the smaller chain size, the opposing whelps from the large wildcat profiles (4) guide the smaller chain into the small wildcat profile. Opposing whelps on the small wildcat profile (5) then guide alternating chain links in the same manner as described above. Guidance, rotational power, and braking can be applied to the smaller chain size through the pockets (7) and whelp flats (10) in a similar manner to that described above. Although FIGS. 1 and 2 only show two wildcat profiles, any number may be used depending on the number of different chain sizes encountered.

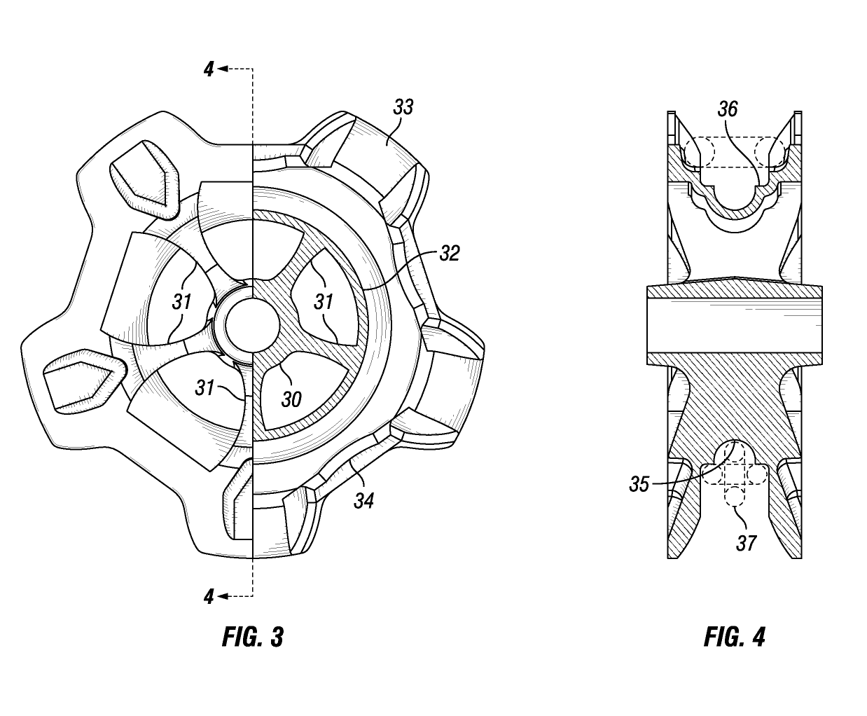

FIG. 3 is a side partial cutaway of a dual pocket chain wheel with a groove designed to carry the smaller chain in a “+” orientation. The dual pocket chain wheel is shown in a hub and spoke configuration. The hub (30) defines the centerline hole. Spokes (31) space the rim (32) a distance away from center line.

The dual chain wheel shown in FIGS. 3 and 4 has a wildcat profile defined by a number of whelps (33) equally spaced around a rim (32). Pockets (34) are located between the whelps (33). The whelps (33) orient the large chain links in the same manner described in FIGS. 1 and 2. Guidance, rotational power and braking is also applied to the chain links in the large chain through the pocket flats and whelp flats as previously described.

Opposing whelps (33) are spaced to guide the small chain into the inner channel (35). The inner channel has a ledge (36) that supports and orients the small chain along the inner groove in a “+” orientation (37).

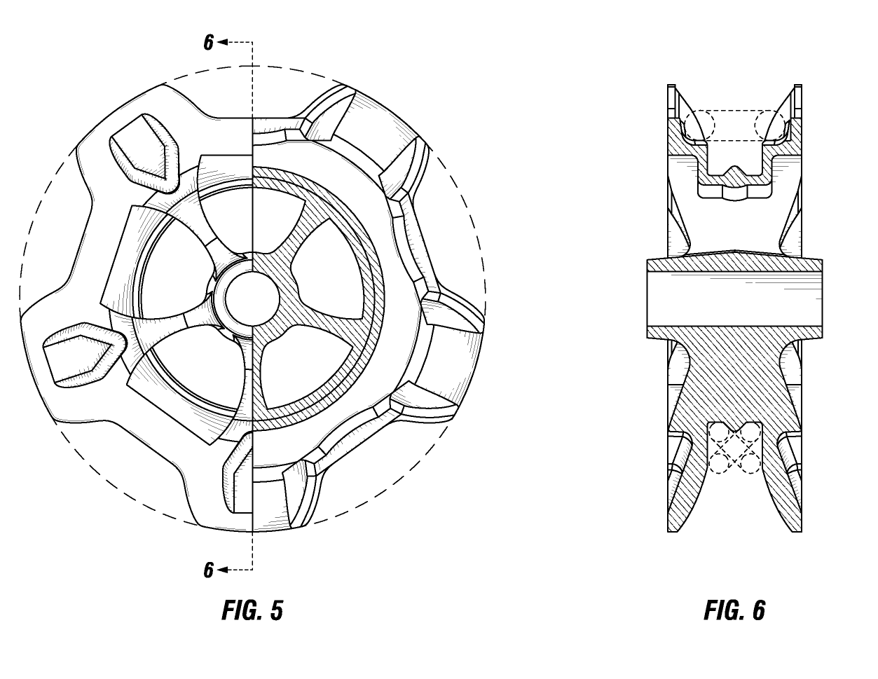

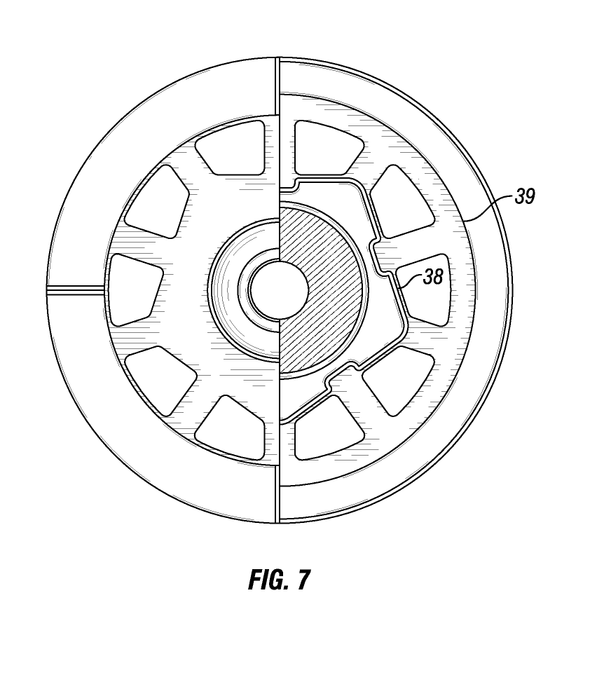

FIGS. 5 and 6 show a different embodiment of the dual chain wheel configuration shown in FIGS. 3 and 4. In the chain wheel shown in FIGS. 5 and 6 the inner groove is in the shape of a “W” to guide the small chain in an x configuration.

FIG. 7 show a different embodiment of the dual chain wheel in which an outer groove (39) supports the large sized chain and flats (38) support the smaller chain size. As described above, the flats (38) support and distribute the load on the chain across the flat portion that is in contact with the chain link.

The inventive method and apparatus described above is well adapted for use with chain mooring systems, and thus the description focuses on this application of the invention. However, it shall be noted that the foregoing description is presented for purposes of illustration and description, and is not intended to limit the invention to the form disclosed herein. Consequently, variations and modifications to the method and apparatus commensurate with the above teachings and teaching of the relevant art are within the scope of the invention. For example, as mentioned previously, several aspects of the invention may be adapted for use in various tasks involving chain, cable, rope, or the like that involve gripping, guiding, or controlling chain, cable, rope, or the like.

Moreover, the embodiments described are further intended to explain the best modes for practicing the invention, and to enable others skilled in the art to utilize the invention in such, or other, embodiments and with various modifications required by the particular applications or uses of the present invention. It is intended that the appending claims be construed to include alternative embodiments to the extent that it is permitted by the prior art.

What is claimed:

1. A chain wheel comprising;
a wheel hub;
a first outer wildcat profile positioned about the hub;
a second outer wildcat profile positioned about the hub in spaced relation with the first outer wildcat profile;
a first inner wildcat profile positioned about the hub and generally adjacent the first outer wildcat profile; and
a second inner wildcat profile positioned about the hub in spaced relation with the first inner wildcat profile and generally adjacent the second outer wildcat profile.

2. The chain wheel of claim 1, wherein the pair of outer wildcat profiles is adapted to engage a first chain segment size and the pair of inner wildcat profiles is adapted to engage a second chain segment size.

3. A chain wheel as in claim 1, wherein each of the wildcat profiles has a plurality of whelps, and wherein pairs of spaced-apart whelps are adapted to position chain segments between pairs of wildcat profiles.

4. A chain wheel as in claim 3, wherein the whelps of the first and second inner wildcat profiles are aligned with respective whelps of the first and second outer wildcat profiles.

5. A chain wheel as in claim 1, wherein each of the inner wildcats is rotatably adjustable about the hub relative to an outer wildcat.

6. A chain wheel as in claim 1 or 5, further comprising radiused pockets formed between adjacent whelps for accommodating horizontally disposed links.

7. A chain wheel comprising a rim;
a first wildcat profile attached to the rim; and
a second wildcat profile attached to the forming in spaced-apart relation with the first wildcat profile, such that a channel is formed between the first and second wildcat profiles.

8. A chain wheel as in claim 7, further comprising a groove disposed within the channel, the groove adapted to accommodate a chain segment of first size, and wherein the pairs of wildcat profiles is adapted to accommodate a chain segment of a second size.

9. A chain wheel as in claim 8 wherein the groove is radiused, the radiused groove having a diameter less than that of the channel.

10. A chain wheel as in claim 9, wherein the inner channel is W-shaped

11. A method of hauling in chain comprising the steps of,
feeding a chain through a chain wheel adapted for multiple chain sizes;
applying rotational power to said chain wheel; and
storing chain that has been hauled in.

12. The method of claim 11 further comprising the step of rotatably positioning an outer wildcat profile to accommodate a larger chain link size.

13. A method of paying out chain comprising the steps of,
paying out chain through a chain wheel adapted for multiple chain sizes;
applying braking as required to said chain wheel; and
rotatably positioning an inner wildcat profile to accommodate a smaller chain link size.

14. A method of manipulating a chain having a plurality of chain segment sizes, said method comprising the steps of:
providing a chain wheel having a hub and a pair of drums disposed thereon in spaced parallel relation with one another, each drum having a plurality wildcat profiles for engaging the chain segments;
employing a first pair of wildcat profiles to engage chain segments of first size during forward or rearward manipulation of the chain; and
employing a second pair of wildcat profiles to engage chain segments of second size during rearward or forward manipulation of the chain.

15. The method of claim 14, wherein the steps of employing a pair of wildcat profiles to engage chain segments drives rearward of forward progress of the chain.

16. The method of claim 14, wherein the steps of employing a pair of wildcat profiles to engage chain segments guides rearward or forward progress of the chain.

17. The method of claim 14, wherein the steps of employing a pair of wildcat profiles to engage the chain segments brakes rearward or forward progress of the chain.

18. The method of claim 14, wherein each drum has an outer wildcat profile and an inner wildcat profile disposed generally adjacent the outer wildcat profile, said method further comprising the step of rotating each of a pair of one of the inner and outer wildcat profiles to accommodate the chain segment of the second size.

19. A chain wheel comprising,
a first pocket shaped to receive and guide a first chain size;
a second pocket shaped to receive and guide a second chain size, wherein said second pocket is positioned interior of said first pocket.

20. The chain wheel of claim 19, wherein said second pocket includes pocket flats sized to support the second chain size.

21. The chain wheel of claim 20, wherein said first pocket includes flats sized to support the first chain size.

22. The chain wheel of claim 21, wherein said first pocket includes whelps sized to fit a first chain size.

23. The chain wheel of claim 22, wherein the whelps of said first pocket are shaped to guide a chain of a second size into said second pocket.

24. The chain wheel of claim 23, wherein said second pocket rotates independently of said first pocket.
